(19) United States
(12) Patent Application Publication
(10) Pub. No.: US 2003/0139200 A1
(43) Pub. Date: Jul. 24, 2003

(54) Communication system, system information download method, main apparatus, and server apparatus

(76) Inventor: Takanori Kaji, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/337,396

(22) Filed: Jan. 7, 2003

(30) Foreign Application Priority Data
Jan. 18, 2002 (JP) 2002-010566

(51) Int. Cl. H04M 1/00

(52) U.S. Cl. 455/554; 455/555

(57) ABSTRACT

Upon providing the same functions as those of telephone terminals in a telephone system to a mobile communication terminal outside the telephone system, the mobile communication terminal transmits a download request of system information to a main apparatus in the telephone system. This download request contains an user ID and a telephone number of the mobile communication terminal. The main apparatus compares the user ID contained in the download request with those stored and managed in the user database so as to check user's authenticity. The main apparatus then accesses the mobile communication terminal via a public network on the basis of the telephone number, and transmits the requested system information, thus providing the same functions as those of the telephone terminals.

### CROSS-REFERENCE TO RELATED APPLICATIONS

This application is based upon and claims the benefit of priority from the prior Japanese Patent Application No. 2002-010566, filed Jan. 18, 2002, the entire contents of which are incorporated herein by reference.

### BACKGROUND OF THE INVENTION

1. Field of the Invention

The present invention relates to a communication system and system information download method, which download unique system information of a telephone terminal in a telephone system, which is equipped in, e.g., an office, business establishment, or the like, from a main apparatus in the telephone system to a communication device connected to a public network, a main apparatus and a server apparatus having a function of implementing this method.

2. Description of the Related Art

In an office, business establishment, or the like, many main apparatuses such as a digital private branch exchange, key telephone apparatus, and the like are used. This main apparatus accommodates many telephone terminals, and forms one telephone system.

In recent years, as the functions of the telephone system have improved, there are strong needs for using the telephone system in an office from a remote place outside the office.

In order to use the telephone system in the office from a remote place outside the office, use limitations from remote places outside the office and security against illicit accesses must be assured, and access procedures and means from remote places outside the office as well as that security measure must be accomplished.

Also, since a dedicated terminal used in access is required, the user must carry that dedicated terminal so as to use the telephone system in the office from a remote place outside the office. Hence, much labor and time are required upon introduction, and the cost load becomes heavy.

### BRIEF SUMMARY OF THE INVENTION

It is an object of the present invention to provide a communication system, system information download method, main apparatus and server apparatus which allow system information used in a telephone terminal in a telephone system to be used outside the system, can reduce the cost load on the user and labor, and can improve system security.

A communication system according to an aspect of the present invention is directed to a communication system which comprises telephone terminals, and a main apparatus connected to these telephone terminals via a line, and can connect a communication device to the main apparatus via a communication network, the main apparatus comprising: an user database which stores system information associated with functions of the telephone terminals in correspondence with individual identification information assigned to users of the telephone terminals; a request reception unit which receives a download request of system information, which comes from the communication device and contains individual identification information of an user himself or herself; a system information read unit which reads out corresponding system information from the user database on the basis of the user's individual identification information contained in the download request; a system information transmission unit which transmits the system information read out from the user database to the communication device as a request source; a judging unit which judges if the communication device has been connected via the communication network for a predetermined period of time; and a re-transmission instruction unit which sends a re-transmission instruction of the download request of the system information to the communication device when it is judged that the communication device has been connected for the predetermined period of time, and the communication device comprising: a request transmission unit which transmits the download request of the system information to the main apparatus; a system information reception unit which receives system information that comes from the main apparatus via the communication network in response to the download request; and a function execution unit which executes a function of the corresponding telephone terminal on the basis of the system information.

A system information download method according to another aspect of the present invention is directed to a system information download method, which is applied to a telephone system that comprises telephone terminals and a main apparatus connected to the telephone terminals via a line, and can connect a communication device and the main apparatus via a communication network, and which distributes system information from the main apparatus to the communication device. The main apparatus has an user database that stores system information associated with functions of the telephone terminals in correspondence with individual identification information assigned in advance to users of the telephone terminals. In this method, the communication device transmits a download request of the system information including individual identification information of an user own, to the main apparatus. The main apparatus reads out corresponding system information from the user database on the basis of the individual identification information of the download request coming from the communication device. The system information read out from the user database is downloaded from the main apparatus to the communication device as a request source. The main apparatus judges the state of the communication device which has been connected via the communication network. When it is judged that the communication device has been connected to the main apparatus for a predetermined period of time, the main apparatus transmits a re-transmission instruction of the download request of the system information to the communication device.

Furthermore, a main apparatus according to still another aspect of the present invention is directed to a main apparatus, which can be connected to a communication device via a communication network, and is connected to telephone terminals via a line, comprising: an user database which stores system information associated with functions of the telephone terminals in correspondence with individual identification information assigned to users of the telephone terminals; a request reception unit which receives a download request of system information, which comes from the communication device via the communication network, and contains individual identification information of an user himself or herself; a system information read unit which reads out corresponding system information from the user database on the basis of the user's individual identification information contained in the download request; a system information transmission unit which transmits the system information read out from the user database to the communication device as a request source; a judging unit which judges if the communication device has been connected via the communication network for a predetermined period of time; and a re-transmission instruction unit which sends a re-transmission instruction of the download request of the system information to the communication device when it is judged that the communication device has been connected for the predetermined period of time.

Furthermore, A server apparatus, which can be connected to a communication device via a communication network, and is connected to telephone terminals via a line, comprising: an user database which stores system information associated with functions of the telephone terminals in correspondence with individual identification information assigned to users of the telephone terminals; a request reception unit which receives a download request of system information, which comes from the communication device via the communication network, and contains individual identification information of an user himself or herself; a system information read unit which reads out corresponding system information from the user database on the basis of the user's individual identification information contained in the download request; a system information transmission unit which transmits the system information read out from the user database to the communication device as a request source; a judgment unit which judges if the communication device has been connected via the communication network for a predetermined period of time, generates a judgment signal indicating that the communication device has been connected for the predetermined period of time; and a re-transmission instruction unit which sends a re-transmission instruction of the download request of the system information to the communication device in response to the judgment signal.

### BRIEF DESCRIPTION OF THE SEVERAL VIEWS OF THE DRAWING

FIG. 1 is a schematic diagram of a system that practices a system information download method according to a first embodiment of the present invention;

FIG. 2 is a block diagram showing the arrangement of a main apparatus shown in FIG. 1;

FIG. 3 shows an example of the storage contents of an user database shown in FIG. 2;

FIG. 4 is a block diagram showing a mobile communication terminal shown in FIG. 1;

FIG. 5 is a signal sequence chart for explaining the system information download method in the first embodiment;

FIG. 6 is a flow chart showing the processing sequence and contents of a controller in the main apparatus shown in FIG. 2;

FIG. 7A is a screenshot showing a sequence for issuing a download request of system information at the mobile communication terminal;

FIG. 7B is a screenshot showing a sequence for issuing a download request of system information at the mobile communication terminal;

FIG. 8A is a screenshot showing a sequence for executing a function of a telephone terminal at the mobile communication terminal;

FIG. 8B is a screenshot showing a sequence for executing a function of a telephone terminal at the mobile communication terminal; and

FIG. 8C is a screenshot showing a sequence for executing a function of a telephone terminal at the mobile communication terminal.

FIG. 8D is a screenshot showing a sequence for executing a function of a telephone terminal at the mobile communication terminal.

FIG. 9 is a schematic diagram of a system that practices a system information download method according to a second embodiment of the present invention;

FIG. 10 is a block diagram showing the arrangement of a main apparatus shown in FIG. 9; and

FIG. 11 is a signal sequence chart for explaining the system information download method in the second embodiment.

### DETAILED DESCRIPTION OF THE INVENTION

An embodiment of the present invention will be described in detail hereinafter with reference to the accompanying drawings.

### A First Embodiment

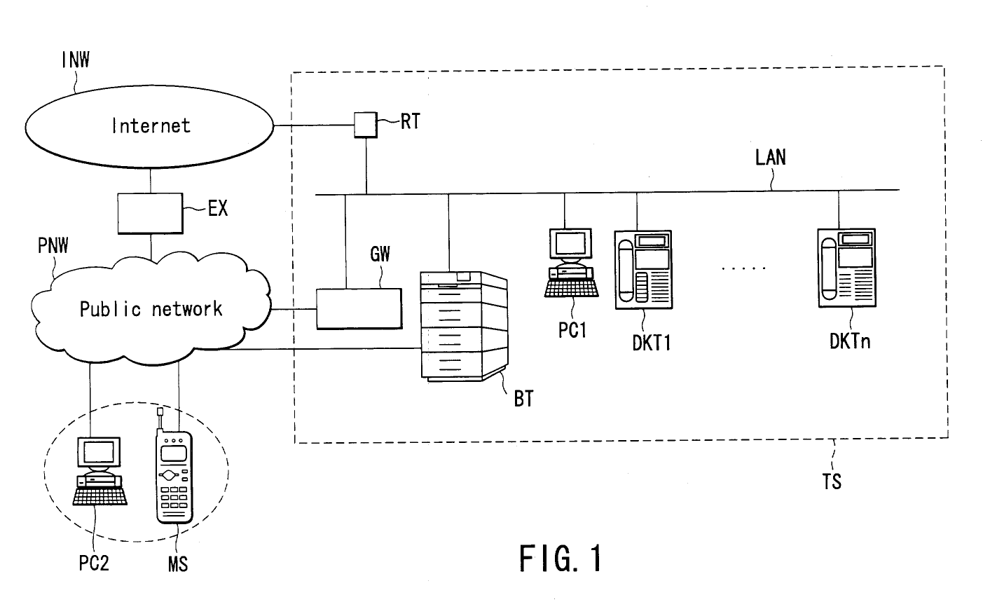

FIG. 1 is a schematic diagram of a support system that practices a system information download method according to the first embodiment of the present invention. Reference symbol TS denotes a telephone system; MS, a mobile communication terminal; and PC1 and PC2, personal computers.

The telephone system TS comprises a main apparatus BT, the personal computer PC1, telephone terminals DKT1 to DKTn, a router RT, and a gateway GW, and interconnects these components via a LAN. The router RT controls connections and communications between an Internet INW, and the main apparatus BT, personal computer PC1, and telephone terminals DKT1 to DKTn, which are connected to the LAN.

The gateway GW controls connections and communications between a public network PNW, and the main apparatus BT, personal computer PC1, and telephone terminals DKT1 to DKTn, which are connected to the LAN.

The Internet INW and public network PNW are connected to an exchange station EX via wired lines. Furthermore, the mobile communication terminal MS and personal computer PC2 are connected to the public network PNW.

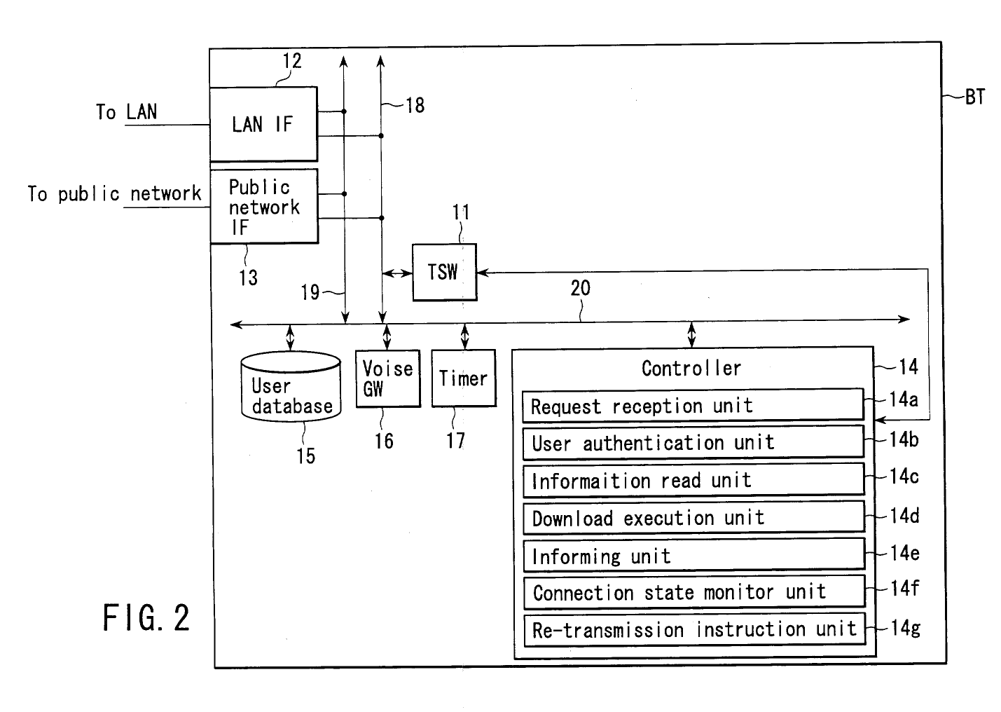

FIG. 2 is a block diagram showing the detailed arrangement of the main apparatus BT.

The main apparatus BT comprises a time switch (TSW) 11, LAN interface (LAN IF) 12, public network interface (public network IF) 13, controller 14, user database 15, voice gateway (voice GW) 16, and timer 17. Of these components, the time switch 11, LAN interface 12, and public network interface 13 are interconnected via a PCM highway 18. Also, the LAN interface 12 and public network interface 13 are interconnected via a data highway 19.

The controller 14, user database 15, voice gateway 16, and timer 17 are connected via a CPU bus 20. Note that the time switch 11 is directly connected to the controller 14. The PCM highway 18, data highway 19, and CPU bus 20 are interconnected.

The time switch 11 arbitrarily exchanges and connects the LAN interface 12 and public network interface 13 by interchanging time slots on the PCM highway 18 under the control of the controller 14.

A LAN is connected to the LAN interface 12 as needed. The LAN interface 12 makes interface operations associated with the connected LAN. The interface operations include conversion of voice packets given via the LAN into PCM signals, conversion of PCM signal given via the time switch 11 into voice packets, status monitor of the LAN, output of various signals to a network connected via the LAN, and the like. The LAN interface 12 exchanges various kinds of control information associated with the above interface operations with the controller 14 via the data highway 19 and CPU bus 20.

A public network PNW is connected to the public network interface 13 as needed. The public network interface 13 makes interface operations associated with the connected public network PNW. The public network interface 13 exchanges various kinds of control information associated with the above interface operations with the controller 14 via the data highway 19 and CPU bus 20.

The controller 14 comprises a CPU, ROM, and RAM, and executes processes based on an operation program stored in the ROM, thus systematically controlling the time switch 11, LAN interface 12, and public network interface 13, and implementing the operations of the main apparatus BT.

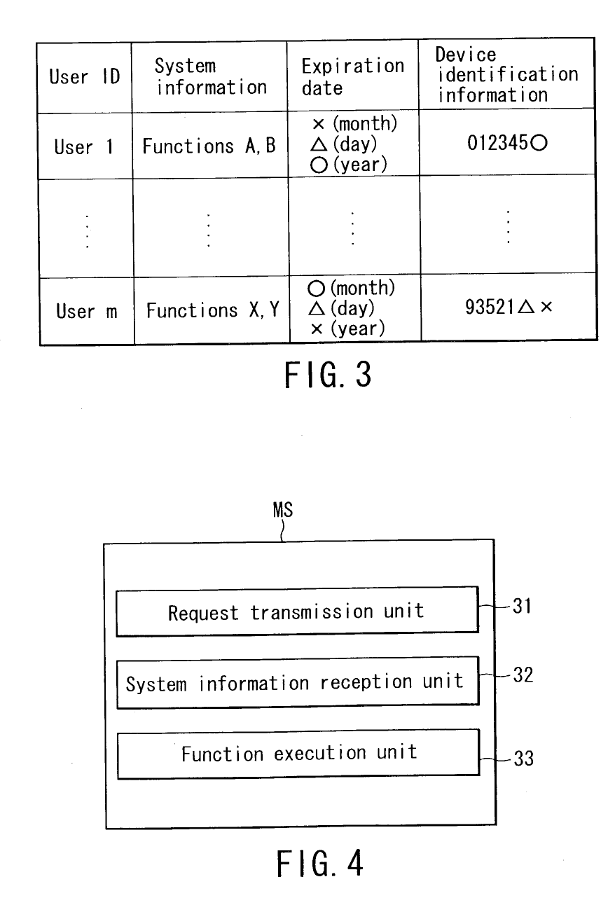

As shown in FIG. 3, the user database 15 stores system information associated with functions of each of the personal computer PC1 and telephone terminals DKT1 to DKTn, an expiration date of download permission, and device identification information in correspondence with individual identification information (user ID) of the user of each of the personal computer PC1 and telephone terminals DKT1 to DKTn. Note that the system information contains setup information indicating the functions of each of the personal computer PC1 and telephone terminals DKT1 to DKTn, and a telephone application software which runs based on this setup information. The setup information contains information of key assignment set by the user and the like, a service range specified by the user's contract, and the like.

The voice gateway 16 executes connection and communication processes associated with voice signals.

The timer 17 measures the current date and time.

The controller 14 of this embodiment comprises a request reception unit 14a user authentication unit 14b, information read unit 14c, download execution unit 14d, informing unit 14e, connection state monitor unit 14f, and re-transmission instruction unit 14g, as new functions according to the present invention.

The request reception unit 14a receives a download request which contains an user ID, and comes from the mobile communication terminal MS or personal computer PC2 via the public network PNW and Internet INW.

The user authentication unit 14b checks user authenticity on the basis of the user ID contained in the download request received by the request reception unit 14a, and user IDs stored in the user database 15.

The information read unit 14c reads out system information, information indicating the expiration date, and device identification information corresponding to the user ID of the request source from the user database 15, when the user authentication unit 14b determines that the user of the request source is authentic.

The download execution unit 14d checks if the expiration date has been reached, by comparing the expiration date of the system information read out by the information read unit 14c with the current date and time measured by the timer 17, and then transmits the system information to the mobile communication terminal MS or personal computer PC2 as the request source via the public network PNW. In this case, the system information is encrypted using the device identification information before transmission.

The informing unit 14e sends a message indicating that system information cannot be downloaded, and a reason for it to the mobile communication terminal MS or personal computer PC2 as the request source, when the expiration date before which download of system information is permitted has been reached, or when user authentication has failed.

The connection state monitor unit 14f monitors the connection state of the mobile communication terminal MS or personal computer PC2 as the request source.

The re-transmission instruction unit 14g instructs the mobile communication terminal MS or personal computer PC2 as the request source to re-transmit a download request of system information when the connection state monitor unit 14f determines that the mobile communication terminal MS or personal computer PC2 as the request source has been connected to the main apparatus BT for a predetermined period of time.

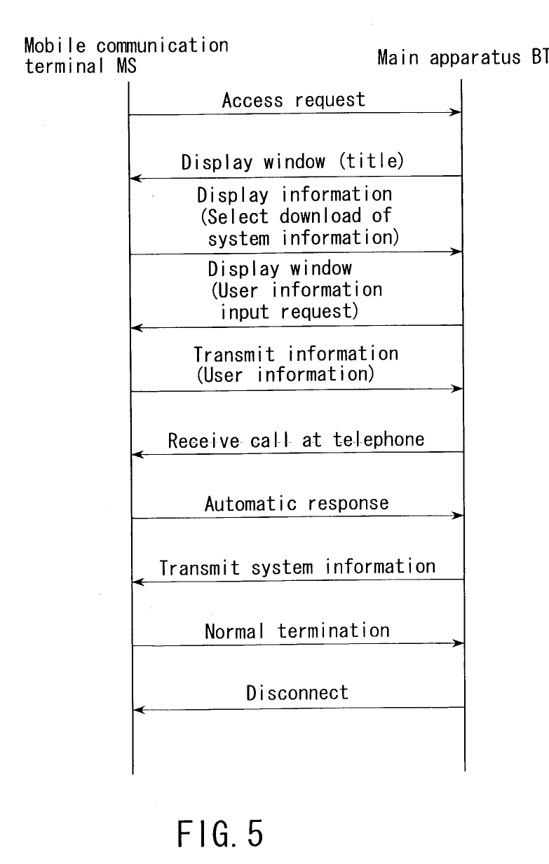

FIG. 4 is a block diagram showing the functional arrangement of the mobile communication terminal MS.

The mobile communication terminal MS comprises a request transmission unit 31, system information reception unit 32, and function execution unit 33 as functions according to the present invention.

The request transmission unit 31 transmits a download request of system information to the main apparatus BT.

The system information reception unit 32 receives system information which comes from the main apparatus BT via the Internet INW, exchange station EX, and public network PNW in response to the download request transmitted by the request transmission unit 31.

The function execution unit 33 executes functions of a corresponding one of the personal computer PC and telephone terminals DKT1 to DKTn until a re-transmission instruction of a download request is received from the main apparatus BT.

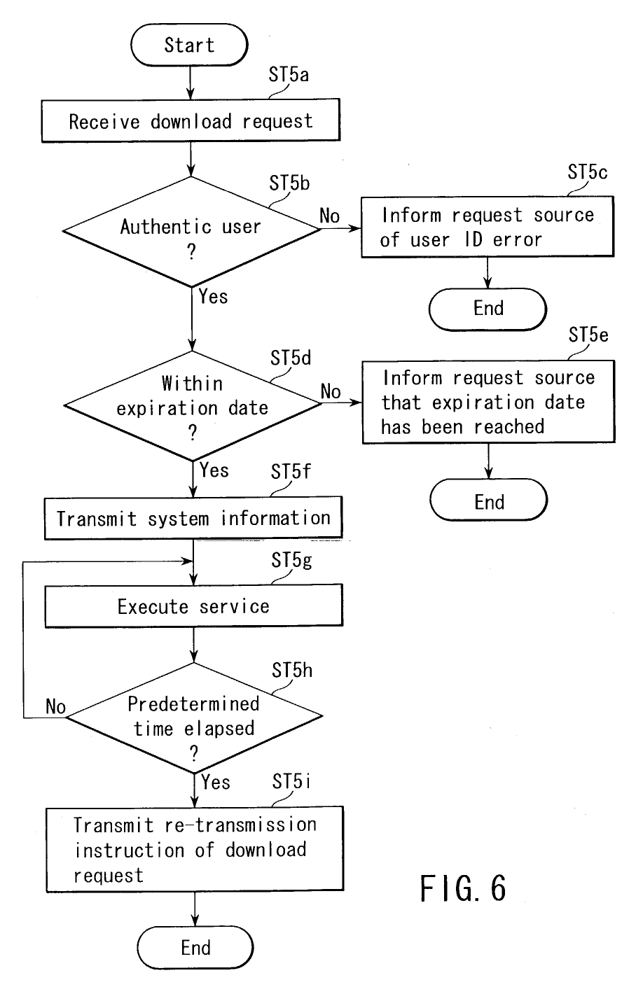

A sequence upon downloading system information to, e.g., the mobile communication terminal MS as the request source in the aforementioned system will be explained below. FIG. 5 is a sequence chart showing information transmission/reception operations between the mobile communication terminal MS and main apparatus BT.

Upon downloading system information, the user accesses the main apparatus BT via the public network PNW and Internet INW using the mobile communication terminal MS, and inputs necessary information associated with download of system information in accordance with a guidance on a indication information downloaded from the main apparatus BT. In this case, the user inputs, as the necessary information, his or her user ID, and a telephone number or IP address assigned from the public network PNW to the mobile communication terminal MS. Upon input of such necessary information, a download request which contains the information is transmitted to the main apparatus BT.

Upon receiving the download request, the main apparatus BT compares the user ID of the user with those stored in the user database 15 to check if the user is authentic, and also if the expiration date before which download of system information is permitted is reached.

If no problems are found, the main apparatus BT accesses the user's mobile communication terminal MS via the public network PNW on the basis of the telephone number contained in the download request, and transmits system information corresponding to the user. In this case, this system information is encrypted by device identification information.

Upon receiving the system information from the main apparatus BT, the mobile communication terminal MS decrypts the received information using device identification information of the self terminal. Then, the mobile communication terminal MS can execute the same telephone services as those of the personal computer PC1 and telephone terminals DKT1 to DKTn.

Upon completion of this service process, the mobile communication terminal MS returns to the main apparatus BT information indicating that the services are normally terminated.

Upon receiving the termination message from the mobile communication terminal MS, the main apparatus BT disconnects the line with the mobile communication terminal MS.

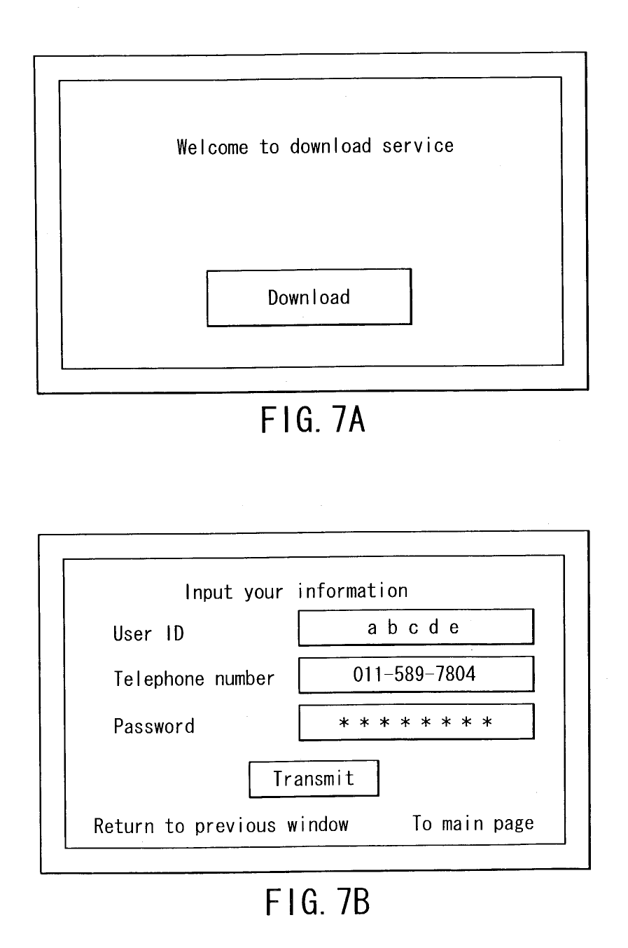

FIG. 6 is a flow chart showing the operation of the main apparatus BT upon executing the aforementioned processing sequence.

Upon receiving a download request which comes from the mobile communication terminal MS via the Internet INW (step ST5a), the controller 14 in the main apparatus BT compares the user ID contained in this download request with those stored in the user database 15 to check the user authenticity (step ST5b). If it is determined that the user is unauthentic (No), the controller 14 informs the mobile communication terminal MS as the request source of an user ID error (step ST5c), and disconnects the line with the mobile communication terminal MS.

On the other hand, if it is determined that the user is authentic (Yes), the controller 14 compares the expiration date stored in the user database 15 with the date and time measured by the timer 17 to check if the expiration date is reached (step ST5d). If the expiration date has been reached (No), the controller 14 sends a message indicating that the expiration date has been reached to the mobile communication terminal MS as the request source (step ST5e), and disconnects the line with the mobile communication terminal MS.

On the other hand, if it is determined that the expiration date is not reached (Yes), the controller 14 encrypts the requested system information using device identification information, and transmits it to the mobile communication terminal MS as the request source (step ST5f).

After the system information is transmitted, the controller 14 executes telephone services in step ST5g while monitoring an elapse of time in step ST5h.

If a predetermined period of time has elapsed (Yes), the controller 14 transmits a re-transmission instruction of a download request of system information to the connected mobile communication terminal MS (step ST5i), and suspends services if authentication has failed.

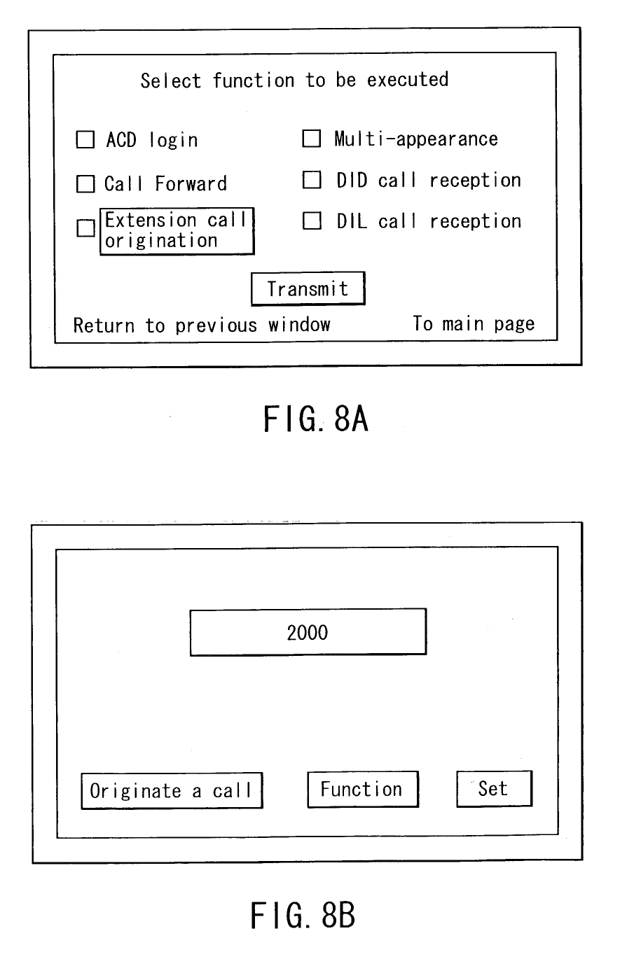

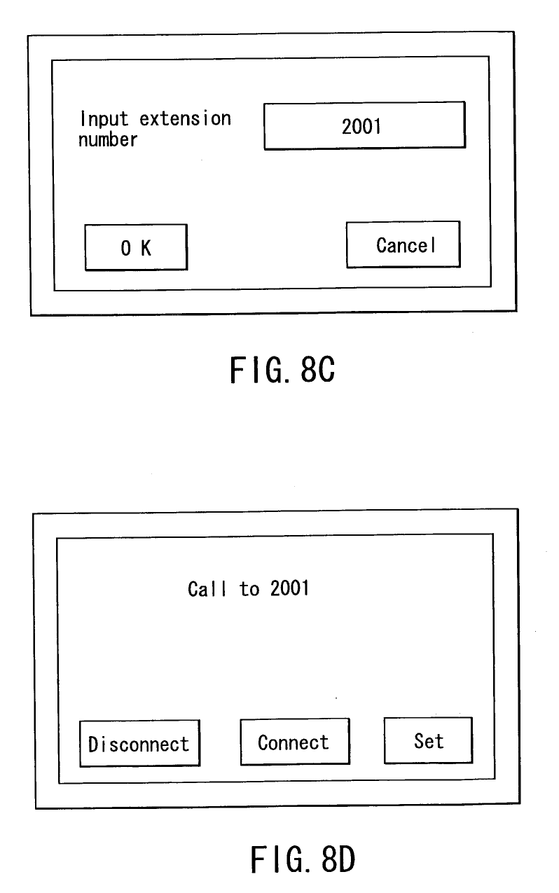

FIGS. 7A to 8D are screenshots showing the processing sequence of the mobile communication terminal MS during the download process of system information.

When the user wants to use functions which are available in the telephone terminals DKT1 to DKTn in the telephone system TS, he or she accesses the main apparatus BT via the public network PNW and Internet INW using the mobile communication terminal MS, selects “download” in accordance with a guidance on a indication information shown in FIG. 7A, which is downloaded from the main apparatus BT, and inputs necessary information associated with download of system information in accordance with a guidance on a indication information shown in FIG. 7B. The necessary information to be input includes the user ID and a telephone number and password assigned from the public network PNW to the mobile communication terminal MS. When the user has input such necessary information and selected “transmit”, the mobile communication terminal MS transmits a download request that includes the above information to the main apparatus BT.

After the system information is downloaded from the main apparatus BT to the mobile communication terminal MS, the user of the mobile communication terminal MS selects a function to be executed, e.g., “extension call”, in accordance with a indication information shown in FIG. 8A. Upon completion of selection, when the user has selected “transmit”, the mobile communication terminal MS transmits such information to the main apparatus BT.

After the indication information shown in FIG. 8B is downloaded from the main apparatus BT to the mobile communication terminal MS.

Assume that the user of the mobile communication terminal MS selects “Originate a call” in accordance with a indication information shown in FIG. 8B, inputs an extension number “2001”, selects “OK” in accordance with a indication information shown in FIG. 8C, to originate a call to the telephone terminal DKT1 with the extension number “2001”. Then, the main apparatus BT transmits call incoming data to the telephone terminal DKT1 as a destination to make the telephone terminal DKT1 generate ringing tones. At the same time, the main apparatus BT transmits a indication information shown in FIG. 8D to the mobile communication terminal MS.

As described above, according to the above embodiment, the user database 15 of the main apparatus BT in the telephone system TS stores and manages system information associated with functions of each of the personal computer PC1 and telephone terminals DKT1 to DKTn in correspondence with the user ID assigned to the user of each of the personal computer PC1 and telephone terminals DKT1 to DKTn in the telephone system TS. Then, the user need only issue a download request of system information to the main apparatus BT in the telephone system TS via the public network PNW and Internet INW using the existing personal computer PC2 or mobile communication terminal MS outside the telephone system, thus downloading the system information from the main apparatus BT to the personal computer PC2 or mobile communication terminal MS as the request source.

Therefore, according to the above embodiment, a function of using system information can be provided to the personal computer PC2 and mobile communication terminal MS, which has no function of using system information, as needed, thus realizing the same system environment as that within the telephone system TS in the home, other public facilities, and the like. The user can quickly download system information to his or her personal computer PC2 or mobile communication terminal MS while saving labor and cost. Furthermore, since the main apparatus BT checks the availability of download of system information to the personal computer PC2 or mobile communication terminal MS as the request source using user information stored and managed by the user database 15, services and functions that the user can use can be limited in a simple procedure. When the personal computer PC2 or mobile communication terminal MS has been connected for a predetermined period of time, authentication is redone. Hence, such connected personal computer or terminal can be prevented from being left unattended for a long period of time, and never adversely influences other communication devices. Also, any illicit acts (e.g., another user purposely steals system information addressed to another communication device and downloads it to his or her communication device) can be prevented.

Also, according to the above embodiment, the authenticity of the user is checked using the user IDs stored in the user database 15 prior to download of system information. Hence, the user authenticity can be reliably checked in advance.

According to the above embodiment, whether or not the expiration date before which download of system information is permitted is reached is checked using the user ID prior to download of system information. Hence, system information can be appropriately downloaded for each user's communication device.

According to the above embodiment, when a download request of system information issued by the user himself or herself is not accepted by any chance, the user can receive a message indicating that the request is not accepted, and a message indicating an user ID error or that the expiration date has been reached.

Moreover, according to the above embodiment, when system information is downloaded from the main apparatus BT to the personal computer PC2 or mobile communication terminal MS as the request source, the system information is encrypted using device identification information assigned to the personal computer PC2 or mobile communication terminal MS. Therefore, even when the system information is accidentally downloaded to another communication device, or when another user purposely steals system information addressed to another communication device and attempts to download it to his or her communication device, wrongful or illicit download can be avoided.

### A Second Embodiment

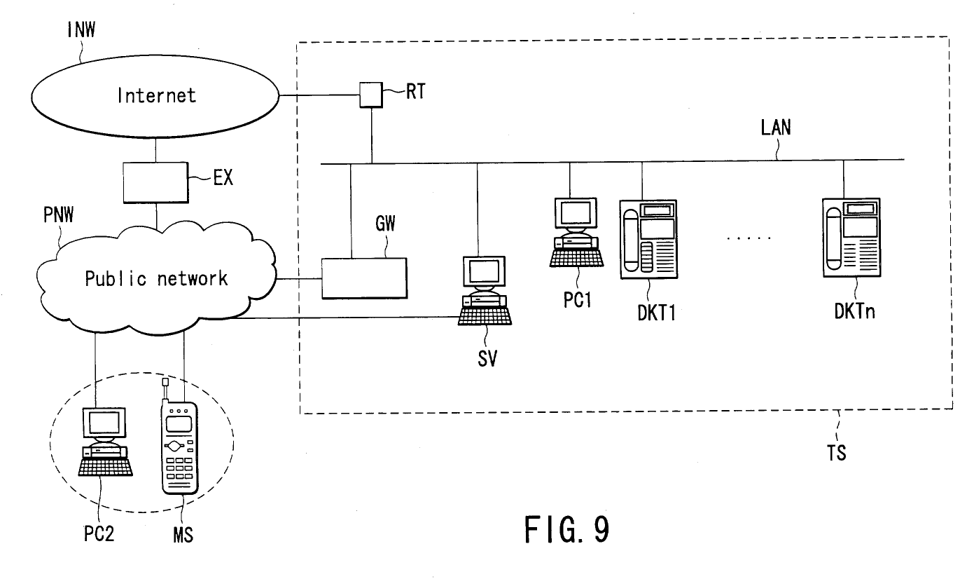

FIG. 9 is a schematic diagram of a support system that practices a system information download method according to the second embodiment of the present invention. Additionally, in FIG. 9, the same components as those of FIG. 1 are denoted with the same reference numerals and detailed description thereof is omitted.

A sever apparatus SV are connected to the LAN, instead of the main apparatus BT. The server apparatus SV has an exchange control function for the personal computer PC1 and telephone terminals DKT1 to DKTn, an assignment function of IP address for the personal computer PC1 and telephone terminals DKT1 to DKTn, and a management function of IP address assigned the personal computer PC1 and telephone terminals DKT1 to DKTn. The public network PNW is connected to the server apparatus SV as needed.

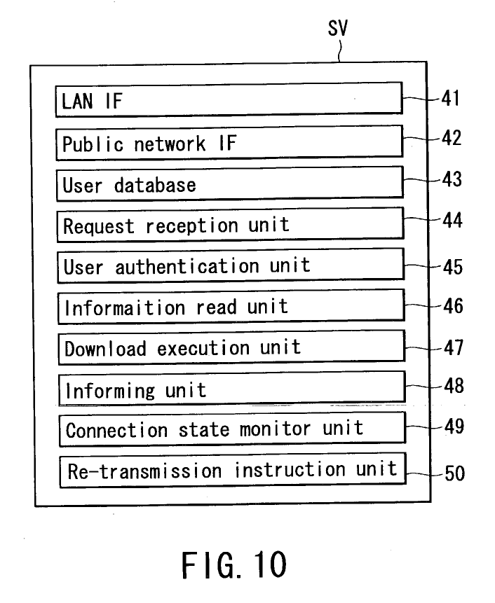

FIG. 10 is a block diagram showing the detailed arrangement of the server apparatus SV.

The server apparatus SV comprises LAN interface (LAN IF) 41, public network interface (public network IF) 42, user database 43, request reception unit 44, user authentication unit 45, information read unit 46, download execution unit 47, informing unit 48, connection state monitor unit 49, and re-transmission instruction unit 50.

The LAN interface 41 makes interface operations associated with the connected LAN. The interface operations include conversion of voice packets given via the LAN into PCM signals, conversion of PCM signal given via the LAN into voice packets, status monitor of the LAN, output of various signals to a network connected via the LAN, and the like.

The public network interface 42 makes interface operations associated with the connected the public network PNW.

The user database 43 stores system information associated with functions of each of the personal computer PC1 and telephone terminals DKT1 to DKTn, an expiration date of download permission, and device identification information in correspondence with individual identification information (user ID) of the user of each of the personal computer PC1 and telephone terminals DKT1 to DKTn.

The request reception unit 44 receives a download request which contains an user ID, and comes from the mobile communication terminal MS or personal computer PC2 via the public network PNW and Internet INW.

The user authentication unit 45 checks user authenticity on the basis of the user ID contained in the download request received by the request reception unit 44, and user IDs stored in the user database 43.

The information read unit 46 reads out system information, information indicating the expiration date, and device identification information corresponding to the user ID of the request source from the user database 43, when the user authentication unit 45 determines that the user of the request source is authentic.

The download execution unit 47 checks if the expiration date has been reached, by comparing the expiration date of the system information read out by the information read unit 46 with the current date and time measured by the timer (no indicate of the diagram), and then transmits the system information to the mobile communication terminal MS or personal computer PC2 as the request source via the public network PNW. In this case, the system information is encrypted using the device identification information before transmission.

The informing unit 48 sends a message indicating that system information cannot be downloaded, and a reason for it to the mobile communication terminal MS or personal computer PC2 as the request source, when the expiration date before which download of system information is permitted has been reached, or when user authentication has failed.

The connection state monitor unit 49 monitors the connection state of the mobile communication terminal MS or personal computer PC2 as the request source.

The re-transmission instruction unit 50 instructs the mobile communication terminal MS or personal computer PC2 as the request source to re-transmit a download request of system information when the connection state monitor unit 14f determines that the mobile communication terminal MS or personal computer PC2 as the request source has been connected to the server apparatus SV for a predetermined period of time.

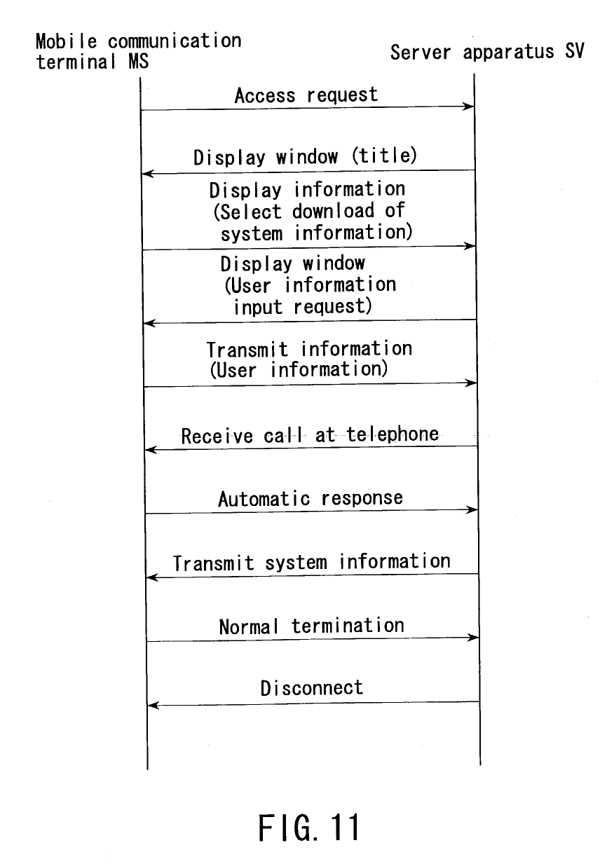

A sequence upon downloading system information to, e.g., the mobile communication terminal MS as the request source in the aforementioned system will be explained below. FIG. 11 is a sequence chart showing information transmission/reception operations between the mobile communication terminal MS and server apparatus SV.

Upon downloading system information, the user accesses the server apparatus SV via the public network PNW and Internet INW using the mobile communication terminal MS, and inputs necessary information associated with download of system information in accordance with a guidance on a indication information downloaded from the server apparatus SV. In this case, the user inputs, as the necessary information, his or her user ID, and a telephone number or IP address assigned from the public network PNW to the mobile communication terminal MS. Upon input of such necessary information, a download request which contains the information is transmitted to the server apparatus SV.

Upon receiving the download request, the server apparatus SV compares the user ID of the user with those stored in the user database 15 to check if the user is authentic, and also if the expiration date before which download of system information is permitted is reached.

If no problems are found, the server apparatus SV accesses the user's mobile communication terminal MS via the public network PNW on the basis of the telephone number contained in the download request, and transmits system information corresponding to the user. In this case, this system information is encrypted by device identification information.

Upon receiving the system information from the server apparatus SV, the mobile communication terminal MS decrypts the received information using device identification information of the self terminal. Then, the mobile communication terminal MS can execute the same telephone services as those of the personal computer PC1 and telephone terminals DKT1 to DKTn.

Upon completion of this service process, the mobile communication terminal MS returns to the server apparatus SV information indicating that the services are normally terminated.

Upon receiving the termination message from the mobile communication terminal MS, the server apparatus SV disconnects the line with the mobile communication terminal MS.

Even in this second embodiment, an action/effect similar to that of the first embodiment is obtained.

### Other Embodiments

Note that the present invention is not limited to the above embodiment. For example, the personal computer PC2 and mobile communication terminal MS have been exemplified as communication devices that the user uses outside the telephone system. However, the present invention can be applied any other communication devices as long as they have a platform which can run telephone application software of the telephone terminals DKT1 to DKTn in the telephone system TS.

In the above embodiment, the setup information and telephone application software are output at one time. However, the present invention is not limited to this. For example, the setup information may be transmitted first, and the telephone application software may then be transmitted. The telephone application software may be run by the server, may be downloaded to a client, and may then be run by the client, may be in-stolen by the client, and may then be run by the client.

In the above embodiment, the telephone system TS includes at least one of the main apparatus BT and the server apparatus SV. However, the present invention is not limited to this. For example, the telephone system TS includes the main apparatus BT and the server apparatus SV. In this case, the main apparatus BT executes a part of the download process, and the server apparatus SV executes another part of the download process.

In addition, the system information download sequence and contents, the arrangement and operation contents of the support system, the arrangement and type in the telephone system, the arrangement and type of the main apparatus, the contents of system information, and the like can be variously modified within the scope of the present invention.

What is claimed is:

1. A communication system which comprises telephone terminals, and a main apparatus connected to these telephone terminals via a line, and can connect a communication device to the main apparatus via a communication network,
the main apparatus comprising:
an user database which stores system information associated with functions of the telephone terminals in correspondence with individual identification information assigned to users of the telephone terminals;
a request reception unit which receives a download request of system information, which comes from the communication device and contains individual identification information of an user himself or herself;
a system information read unit which reads out corresponding system information from the user database on the basis of the user's individual identification information contained in the download request;
a system information transmission unit which transmits the system information read out from the user database to the communication device as a request source;
a judgment unit which judges if the communication device has been connected via the communication network for a predetermined period of time, generates a judgment signal indicating that the communication device has been connected for the predetermined period of time; and
a re-transmission instruction unit which sends a re-transmission instruction of the download request of the system information to the communication device in response to the judgment signal, and
the communication device comprising:
a request transmission unit which transmits the download request of the system information to the main apparatus;
a system information reception unit which receives system information that comes from the main apparatus via the communication network in response to the download request; and
a function execution unit which executes a function of the corresponding telephone terminal on the basis of the system information.

2. A system information download method, which is applied to a telephone system that comprises telephone terminals and a main apparatus connected to the telephone terminals via a line and can connect a communication device to the main apparatus via a communication network, the main apparatus having an user database that stores system information associated with functions of the telephone terminals in correspondence with individual identification information assigned in advance to users of the telephone terminals, and which distributes the system information from the main apparatus to the communication device, comprising:
causing the communication device to transmit a download request of the system information including individual identification information of an user own, to the main apparatus;
causing the main apparatus to read corresponding system information from the user database on the basis of the individual identification information of the download request coming from the communication device;
causing the main apparatus to transmit the system information read out from the user database to the communication device as a request source;
causing the main apparatus to judge if the communication device has been connected via the communication network for a predetermined period of time, to generate a judgment signal indicating that the communication device has been connected for the predetermined period of time; and
causing the main apparatus to transmit a re-transmission instruction of a download request of the system information to the communication device in response to the judgment signal.

3. A main apparatus, which can be connected to a communication device via a communication network, and is connected to telephone terminals via a line, comprising:
an user database which stores system information associated with functions of the telephone terminals in correspondence with individual identification information assigned to users of the telephone terminals;
a request reception unit which receives a download request of system information, which comes from the communication device via the communication network, and contains individual identification information of an user himself or herself;
a system information read unit which reads out corresponding system information from the user database on the basis of the user's individual identification information contained in the download request;
a system information transmission unit which transmits the system information read out from the user database to the communication device as a request source;
a judgment unit which judges if the communication device has been connected via the communication network for a predetermined period of time, generates a judgment signal indicating that the communication device has been connected for the predetermined period of time; and
a re-transmission instruction unit which sends a re-transmission instruction of the download request of the system information to the communication device in response to the judgment signal.

4. An apparatus according to claim 3, further comprising:
an authenticity judging unit which judges user authenticity on the basis of user's individual identification information stored in the user database, and the individual identification information contained in the download request, and
wherein the system information transmission unit permits download of the system information only when it is judged that the user of the request source is authentic.

5. An apparatus according to claim 4, further comprising:
a first judgment information informing unit which informs the communication device as the request source via the communication network of an user authenticity judgment result.

6. An apparatus according to claim 3, wherein the user database stores the system information associated with the functions of the telephone terminals, and information indicating a term of validity of use within which download of the system information is permitted, in correspondence with the individual identification information assigned in advance to the users,
the main apparatus further comprises a permission judging unit which reads out the information indicating a corresponding term of validity of use from the user database on the basis of the user's individual identification information contained in the download request coming from the communication device, and judges based on this term of validity of use if download of the system information is permitted, and
the system information transmission unit permits the communication device as the request source to download the system information only when it is judged that download is permitted.

7. An apparatus according to claim 6, further comprising:
a second judgment information informing unit which informs the communication device as the request source via the communication network of a judgment result of availability of download as well as the term of validity of use.

8. An apparatus according to claim 3, wherein the user database stores the system information associated with the functions of the telephone terminals, and secret device identification information which is assigned in advance to the communication device, in correspondence with the individual identification information assigned in advance to the users,
the system information read unit reads out the corresponding system information, and the device identification information of the communication device from the user database on the basis of the user's individual identification information contained in the download request coming from the communication device, and
the system information transmission unit encrypts the system information using the device identification information read out from the user database, and transmits the encrypted system information to the communication device as the request source.

9. An apparatus according to claim 3, wherein the system information contains at least setup information indicating functions of the telephone terminal, and application software which runs based on this setup information.

10. A communication system which comprises telephone terminals, and a server apparatus connected to these telephone terminals via a line, and can connect a communication device to the server apparatus via a communication network,
the server apparatus comprising:
an user database which stores system information associated with functions of the telephone terminals in correspondence with individual identification information assigned to users of the telephone terminals;
a request reception unit which receives a download request of system information, which comes from the communication device and contains individual identification information of an user himself or herself;
a system information read unit which reads out corresponding system information from the user database on the basis of the user's individual identification information contained in the download request;
a system information transmission unit which transmits the system information read out from the user database to the communication device as a request source;
a judgment unit which judges if the communication device has been connected via the communication network for a predetermined period of time, generates a judgment signal indicating that the communication device has been connected for the predetermined period of time; and
a re-transmission instruction unit which sends a re-transmission instruction of the download request of the system information to the communication device in response to the judgment signal, and
the communication device comprising:
a request transmission unit which transmits the download request of the system information to the server apparatus;
a system information reception unit which receives system information that comes from the server apparatus via the communication network in response to the download request; and
a function execution unit which executes a function of the corresponding telephone terminal on the basis of the system information.

11. A system information download method, which is applied to a telephone system that comprises telephone terminals and a server apparatus connected to the telephone terminals via a line and can connect a communication device to the server apparatus via a communication network, the server apparatus having an user database that stores system information associated with functions of the telephone terminals in correspondence with individual identification information assigned in advance to users of the telephone terminals, and which distributes the system information from the server apparatus to the communication device, comprising:
causing the communication device to transmit a download request of the system information including individual identification information of an user own, to the server apparatus;
causing the server apparatus to read corresponding system information from the user database on the basis of the individual identification information of the download request coming from the communication device;
causing the server apparatus to transmit the system information read out from the user database to the communication device as a request source;
causing the server apparatus to judge if the communication device has been connected via the communication network for a predetermined period of time, to generate a judgment signal indicating that the communication device has been connected for the predetermined period of time; and
causing the server apparatus to transmit a re-transmission instruction of a download request of the system information to the communication device in response to the judgment signal.

12. A server apparatus, which can be connected to a communication device via a communication network, and is connected to telephone terminals via a line, comprising:
an user database which stores system information associated with functions of the telephone terminals in correspondence with individual identification information assigned to users of the telephone terminals;
a request reception unit which receives a download request of system information, which comes from the communication device via the communication network, and contains individual identification information of an user himself or herself;
a system information read unit which reads out corresponding system information from the user database on the basis of the user's individual identification information contained in the download request;
a system information transmission unit which transmits the system information read out from the user database to the communication device as a request source;
a judgment unit which judges if the communication device has been connected via the communication network for a predetermined period of time, generates a judgment signal indicating that the communication device has been connected for the predetermined period of time; and
a re-transmission instruction unit which sends a re-transmission instruction of the download request of the system information to the communication device in response to the judgment signal.

13. An apparatus according to claim 12, further comprising:
an authenticity judging unit which judges user authenticity on the basis of user's individual identification information stored in the user database, and the individual identification information contained in the download request, and
wherein the system information transmission unit permits download of the system information only when it is judged that the user of the request source is authentic.

14. An apparatus according to claim 13, further comprising:
a first judgment information informing unit which informs the communication device as the request source via the communication network of an user authenticity judgment result.

15. An apparatus according to claim 12, wherein the user database stores the system information associated with the functions of the telephone terminals, and information indicating a term of validity of use within which download of the system information is permitted, in correspondence with the individual identification information assigned in advance to the users,
the server apparatus further comprises a permission judging unit which reads out the information indicating a corresponding term of validity of use from the user database on the basis of the user's individual identification information contained in the download request coming from the communication device, and judges based on this term of validity of use if download of the system information is permitted, and
the system information transmission unit permits the communication device as the request source to download the system information only when it is judged that download is permitted.

16. An apparatus according to claim 15, further comprising:
a second judgment information informing unit which informs the communication device as the request source via the communication network of a judgment result of availability of download as well as the term of validity of use.

17. An apparatus according to claim 12, wherein the user database stores the system information associated with the functions of the telephone terminals, and secret device identification information which is assigned in advance to the communication device, in correspondence with the individual identification information assigned in advance to the users,
the system information read unit reads out the corresponding system information, and the device identification information of the communication device from the user database on the basis of the user's individual identification information contained in the download request coming from the communication device, and
the system information transmission unit encrypts the system information using the device identification information read out from the user database, and transmits the encrypted system information to the communication device as the request source.

18. An apparatus according to claim 12, wherein the system information contains at least setup information indicating functions of the telephone terminal, and application software which runs based on this setup information.
